(19) United States
(12) Patent Application Publication
(10) Pub. No.: US 2010/0231052 A1
(43) Pub. Date: Sep. 16, 2010

(54) POWER SUPPLY DEVICE

(75) Inventor: Fei-Hsu Chen, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/417,668

(22) Filed: Apr. 3, 2009

(30) Foreign Application Priority Data
Mar. 13, 2009 (CN) 200910300820.1

(51) Int. Cl. H02J 1/00

(52) U.S. Cl. 307/80

(57) ABSTRACT

A power supply device for supplying power to an electronic device with an electronic tag includes a rectifying and voltage dividing apparatus, a power supply output module, a radio frequency identification (RFID) induction antenna, an RFID information processing module, and a control apparatus. The rectifying and voltage dividing apparatus is configured to rectify and divide an alternating current voltage to output a plurality of divided voltages. The RFID induction antenna is configured to receive information stored in the electronic tag. The RFID information processing module is configured to pick up a charging voltage value from the received information of the RFID induction antenna. The control apparatus is configured to compare the divided voltage values with the charging voltage value, and choose a divided voltage that equals to the charging voltage to provide to the electronic device.

### BACKGROUND

1. Technical Field

The present disclosure relates to power supply devices, and particularly to a power supply device for supplying power to an electronic device with an electronic tag.

2. Description of Related Art

Providing power to an electronic device, such as a personal digital assistant (PDA), a mobile phone, and others, requires design considerations with respect to both the electronic device and power supply device. With regard to the electronic device, most electronic devices provide a distinct power interface for receiving power from a power supply device. For example, many mobile devices presently use universal serial bus (USB) interfaces for communicating and use a separate power interface, such as a connector, for receiving power.

Therefore, interfaces for a particular manufacturer's electronic device may not be compatible with interfaces for electronic devices provided by other manufacturers. However, if the electronic device is lost, users must buy a new electronic device or abandon the power supply device.

### BRIEF DESCRIPTION OF THE DRAWINGS

FIG. 1 is a block diagram of an exemplary embodiment of a power supply device.

FIG. 2 is a schematic diagram of an exemplary embodiment of the power supply device of FIG. 1.

FIG. 3 is a schematic diagram of an exemplary embodiment of the power supply device of FIG. 2 supplying power to an electronic device.

### DETAILED DESCRIPTION

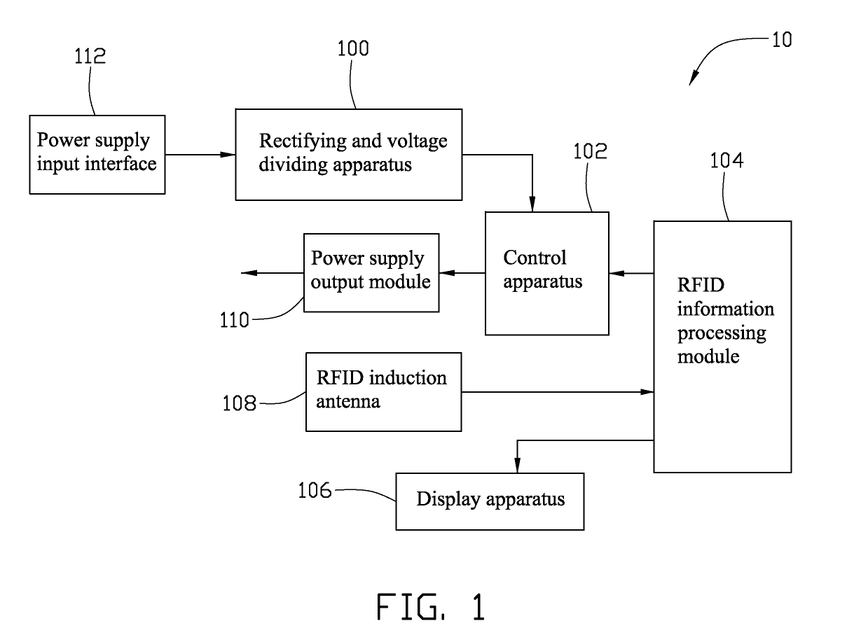

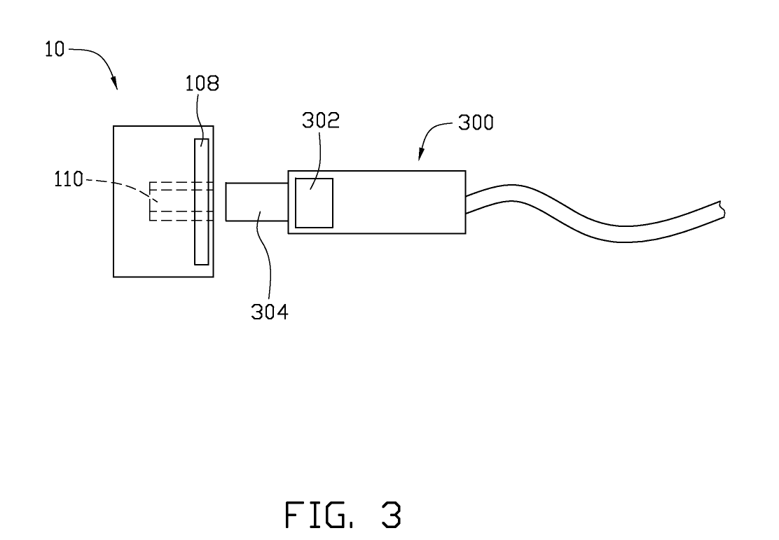

Referring to FIGS. 1 to 3, an exemplary embodiment of a power supply device 10 is configured for providing power to an electronic device 300 with an electronic tag 302. The power supply device 10 includes a rectifying and voltage dividing apparatus 100, a control apparatus 102, a radio frequency identification (RFID) information processing module 104, a display apparatus 106, a plurality of RFID induction antennae 108, a power supply output module 110, and a power supply input interface 112. The electronic device 300 can be a mobile phone, a music player, and includes a charging interface 304.

The power supply output module 110 includes a plurality of power supply output interfaces 114 to connect to a plurality of charging interfaces of a plurality of electronic devices, such as the charging interface 304 of the electronic device 300. One of the power supply output interface 114 matches the charging interface 304, and can be a plug or a socket. In other embodiments, the power supply output interface 114 can be other predetermined structures.

The rectifying and voltage dividing apparatus 100 receives an alternating current (AC) voltage via the power supply input interface 112, converts the AC voltage into a direct current (DC) voltage, divides the DC voltage, and outputs divided DC voltages to the control device 102. For example, the divided DC voltage values can include 1.5 volts, 3 volts, 4 volts, 5 volts, 7 volts, 12 volts, and so on.

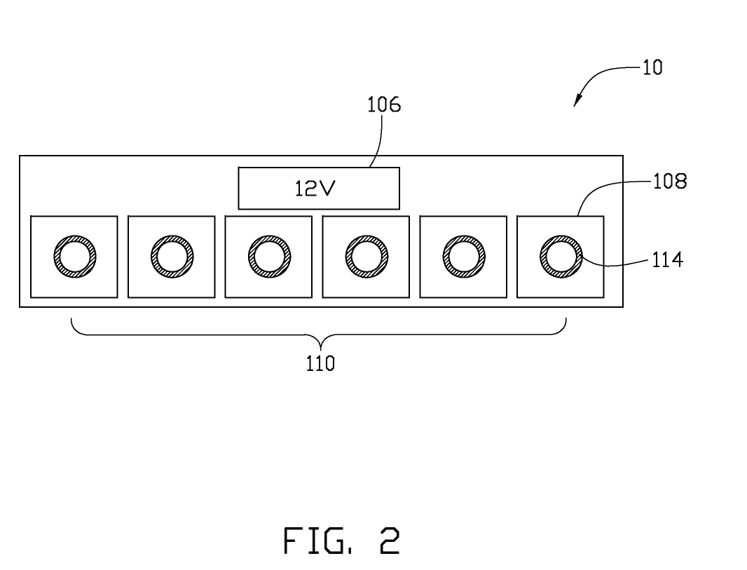

The plurality of RFID induction antennae 108 is configured for receiving information stored in the electronic tag 302 of the electronic device 300. For example, the information stored in the electronic tag 302 can include a serial number (for example TX009), a charging voltage value, such as 3 volts, of the electronic device 300. In this embodiment, each RFID induction antenna 108 surrounds a corresponding power supply output interface 114, to ensure a good communication between the RFID induction antenna 108 and the electronic tag 302 of the electronic device 300 as shown in FIG. 2.

The RFID information processing module 104 is configured for picking up the charging voltage value from the information received by the plurality of RFID induction antennae 108, to output the charging voltage value to the control apparatus 102. And the RFID information processing module 104 is also configured for sending the charging voltage value to the display apparatus 106 to display the charging voltage value. As shown in FIG. 2 the display apparatus 106 displays the charging voltage value of 12 volts. In one embodiment, the display apparatus 106 can be a liquid crystal display.

The control apparatus 102 is configured for comparing the divided voltage value with the charging voltage value. If the charging voltage value equals to one of the divided voltage value, the control apparatus 102 provides the divided voltage that equals to the charging voltage to the electronic device 300 via the power supply output interface 114. If the charging voltage value does not equal to any one of the divided voltage values, the control device 102 provides nothing to the electronic device 300.

In use, an AC voltage is connected to the power supply input interface 112 of the power supply device 10. The charging interface 304 of the electronic device 300 is plugged into a corresponding one of the plurality of power supply output interfaces 114. The rectifying and voltage dividing apparatus 100 rectifies and divides the AC voltage, and outputs divided voltages, such as 1.5 volts, 3 volts, 4 volts, 5 volts, 7 volts, and 12 volts, to the control apparatus 102. The RFID induction antenna 108 corresponding to the power supply output interface 114 receives information stored in the electronic tag 302 of the electronic device 300. The RFID information processing module 104 picks up the charging voltage value, such as 12 volts, from the RFID induction antenna 108, to display the charging voltage value (12 volts) on the display apparatus 106, and outputs the charging voltage value (12 volts) to the control apparatus 102. The control apparatus 102 compares the divided voltage values with the charging voltage value that equals to one of the divided voltage values, therefore the divided voltage 12 volts is provided to the electronic device 300 via the power supply output module 110.

If the charging voltage value of the electronic device 300 is 2 volts which does not equal to any one of the divided voltage values, the power supply device 10 provides nothing to the electronic device 300 so as not to supply wrong power.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A power supply device for supplying power to an electronic device with an electronic tag, comprising:
a rectifying and voltage dividing apparatus configured to rectify and divide an alternating current voltage, and to output a plurality of divided voltages;
a radio frequency identification (RFID) induction antenna configured to receive information stored in the electronic tag;
a power supply output module;
an RFID information processing module connected to the RFID induction antenna, configured to pick up a charging voltage value of the electronic device from the received information of the RFID induction antenna; and
a control apparatus to compare the charging voltage value with the plurality of divided voltage values, wherein if the charging voltage value equals to one of the divided voltage values, the divided voltage that equals to the charging voltage value is provided to the electronic device via the power supply output module; if the charging voltage value does not equal to any one of the divided voltage values, the electronic device supplies nothing.

2. The device of claim 1, further comprising a display apparatus configured for displaying the charging voltage value of the electronic device.

3. The device of claim 2, wherein the display apparatus is a liquid crystal display.

4. The device of claim 1, wherein the plurality of divided voltage values comprises 1.5 volts, 3 volts, 4 volts, 5 volts, 7 volts, and 12 volts.

5. The device of claim 1, wherein the RFID induction antenna surrounds the power supply output interface, to ensure a good communication between the RFID induction antenna and the electronic tag of the electronic device.

6. A power supply device for supplying power to an electronic device with an electronic tag, comprising:
a rectifying and voltage dividing apparatus configured to receive an alternating current (AC) voltage, and rectify and divide the AC voltage to output a plurality of divided voltages;
a radio frequency identification (RFID) induction antenna configured to receive information stored in the electronic tag;
an RFID information processing module connected to the RFID induction antenna, configured to pick up a charging voltage value of the electronic device from the received information of the RFID induction antenna; and
a control apparatus to compare the charging voltage value with the plurality of divided voltage values, and choose a divided voltage that equals to the charging voltage to provide to the electronic device via a power supply output interface.

7. The device of claim 6, further comprising a display apparatus for displaying the charging voltage value of the electronic device.

8. The device of claim 7, wherein the display apparatus is a liquid crystal display.

9. The device of claim 6, wherein the power supply output interface is a plug.

10. A power supply device for supplying power to a plurality of electronic devices each having an electronic tag, the power supply device comprising:
a rectifying and voltage dividing apparatus configured to rectify and divide an alternating current voltage, to output a plurality of divided voltages;
a plurality of radio frequency identification (RFID) induction antennae, configured to receive information stored in the electronic tags correspondingly;
an RFID information processing module connected to the plurality of RFID induction antennae, configured to pick up charging voltage values of the electronic devices from the received information of the plurality of RFID induction antennae; and
a control apparatus to compare the charging voltage values with the plurality of divided voltage values, wherein the control apparatus is capable of supplying the divided voltages that equals to the charging voltage values to the corresponding electronic devices.

11. The power supply device of claim 10, further comprising a plurality of power supply output modules connected to the control apparatus, wherein each of the plurality of power supply is configured to connect a corresponding electronic device.

12. The power supply device of claim 10, further comprising a power supply input interface connected to the rectifying and voltage dividing apparatus, to receive the alternating current voltage.
